(19) United States
(12) Patent Application Publication
(10) Pub. No.: US 2025/0134317 A1
(43) Pub. Date: May 1, 2025

(54) DATA EVALUATION IN A STAND MIXER APPLIANCE

(71) Applicant: Haier US Appliance Solutions, Inc., Wilmington, DE (US)

(72) Inventors: Rocco Cordaro, Louisville, KY (US); Andrew Combs, Louisville, KY (US)

(21) Appl. No.: 18/499,419

(22) Filed: Nov. 1, 2023

(51) Int. Cl. A47J 43/08; A47J 43/044; A47J 43/07

(52) U.S. Cl. CPC A47J 43/082; A47J 43/044; A47J 2043/04454; A47J 2043/0733

(57) ABSTRACT

A stand mixer includes a housing, a motor disposed in the housing, and a controller. The method includes operating the motor to mix food contents, receiving, at the controller, a measurement of an operating parameter of the motor of the stand mixer while operating the motor to mix the food contents, filtering, by the controller, a noise interference from the measurement of the operating parameter of the motor, determining, at the controller, a desired end time based on the filtered measurement of the operating parameter of the motor, and continuing to operate the motor to mix the food contents until reaching the desired end time, whereby the mixing operation is completed.

### FIELD OF THE INVENTION

The present subject matter relates generally to methods of operating stand mixers, and more particularly to methods of evaluating data in stand mixer appliances.

### BACKGROUND OF THE INVENTION

Stand mixers are traditionally used for performing mixing, churning, or kneading operations involved in food preparation. Typically, stand mixers include a motor configured to provide torque to one or more driveshafts. Users may connect various utensils to the one or more driveshafts, including whisks, spatulas, or the like. Operating a stand mixer is frequently a manual process, which involves the user actively monitoring the mixing process. Thus, during the mixing process, a user is positioned close to the mixer in order to monitor the content doneness and to turn-off the stand mixer when the desired doneness is reached. In certain mixing processes, such as whipping cream or kneading dough, the mixing product can become undesirable due to overworking, e.g., overwhipping or excessive kneading, if the user is not actively present. For a user, actively monitoring the stand mixer during the mixing process can be tedious and inconvenient.

Accordingly, a stand mixer configured to prevent overworking ingredients would be advantageous.

### BRIEF DESCRIPTION OF THE INVENTION

Aspects and advantages of the invention will be set forth in part in the following description, or may be apparent from the description, or may be learned through practice of the invention.

In an example embodiment is a method of operating a stand mixer. The stand mixer includes a housing, a motor disposed in the housing, and a controller. The method includes operating the motor to mix food contents, receiving, at the controller, a measurement of an operating parameter of the motor of the stand mixer while operating the motor to mix the food contents, filtering, by the controller, a noise interference from the measurement of the operating parameter of the motor, determining, at the controller, a desired end time based on the filtered measurement of the operating parameter of the motor, and continuing to operate the motor to mix the food contents until reaching the desired end time, whereby the mixing operation is completed.

In another example embodiment, a stand mixer includes a housing, a motor disposed in the housing, and a controller. The controller is configured to operate the motor to mix food contents, receive a measurement of an operating parameter of the motor of the stand mixer while operating the motor to mix the food contents, filter a noise interference from the measurement of the operating parameter of the motor, determine a desired end time based on the filtered measurement of the operating parameter of the motor, and mix the food contents until reaching the desired end time, whereby the mixing operation is completed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side section view of a stand mixer according to an example embodiment of the present disclosure.

FIG. 2 provides a graphical representation of data measurements recorded by a stand mixer according to aspects of the present disclosure.

FIG. 3 provides another graphical representation of data measurements recorded by a stand mixer according to aspects of the present disclosure.

FIG. 4 illustrates a flow diagram of an example method of operating a stand mixer according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

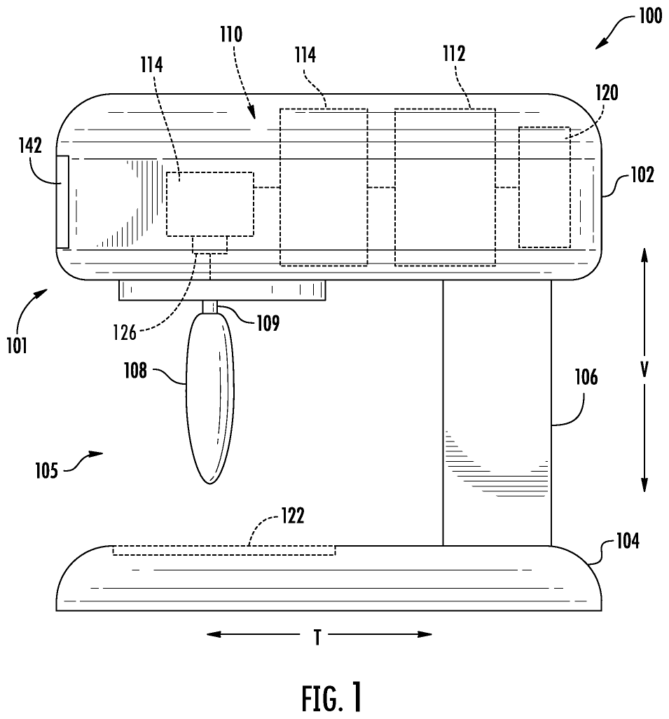

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments. Moreover, stand mixer 100 of FIG. 1 defines a vertical direction V and a transverse direction T, which are perpendicular to each other. It should be understood that these directions are presented for example purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100, which will be described in further detail below. For example, as shown in FIG. 1, a motor 112, a planetary or reduction gearbox 114, and a bevel gearbox 116 may be disposed within motor housing 102. Base 104 may support motor housing 102. For example, motor housing 102 may be mounted (e.g., pivotally) to base 104 via column 106, e.g., that extends upwardly (e.g., along the vertical direction V) from base 104. Motor housing 102 may be suspended over a mixing zone 105, within which a mixing bowl may be disposed and/or mounted to base 104.

A drivetrain 110 may be provided within motor housing 102 and is configured for coupling motor 112 to a shaft 109 (e.g., a mixer shaft), such that shaft 109 is rotatable via motor 112 through drivetrain 110. Drivetrain 110 may include planetary gearbox 114, bevel gearbox 116, etc. Mixer shaft 109 may be positioned above mixing zone 105 on motor housing 102, and an attachment 108, such as a beater, whisk, or hook, may be removably mounted to mixer shaft 109. Attachment 108 may rotate within a bowl (not shown) in mixing zone 105 to beat, whisk, knead, etc. material within the bowl during operation of motor 112.

As noted above, motor 112 may be operable to rotate mixer shaft 109. Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102, and the rotor may be coupled to mixer shaft 109 via drivetrain 110. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and mixer shaft 109.

Stand mixer 100 may include a controller 120 provided within casing 101. In detail, controller 120 may be located within motor housing 102 of casing 101. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 112). For instance, controller 120 may be a printable circuit board (PCB), as would be well known.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, a user interface 142 may include one or more microprocessors and/or one or more memory devices. Accordingly, certain components of stand mixer 100 may be controlled directly from user interface 142.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Controller 120 may be in communication with various sensors, such as a torque meter 126. In the present example embodiment, shown in FIG. 1, the various sensors may include a scale 122 and torque meter 126. Controller 120 may receive signal(s) from scale 122 corresponding to a weight measurement, e.g., of the bowl and materials therein. Scale 122 as shown is an integrated scale within base 104 and is provided for example purposes only. One skilled in the art would appreciate that scale 122 may be another type of scale, e.g., a side scale, a drop scale, or a manual weight selection knob. It will be understood that stand mixer 100 need not include scale 122 in certain example embodiments. Controller 120 may also be in operative communication with or otherwise be connected to torque meter 126, which may be directly or indirectly connected to motor 112. In general, torque meter 126 may measure the torque of motor 112 while motor 112 is mixing food contents. In particular, torque may be directly influenced by the state of the mixture of the food contents, e.g., viscosity of the mixture, which, depending on the recipe, may directly correlate to the completion of the mixing process.

In some example embodiments, controller 120 may be configured to acquire a signal indicative of a parameter of food contents in the stand mixer 100, such as weight from scale 122, as well as a measurement of an operating parameter of motor 112, such as torque from torque meter 126, while motor 112 operates to mix the food contents during a mixing process. In general, the signal indicative of the parameter of food contents in stand mixer 100 may be from one or both of user input and sensor measurement, e.g., a user may input the weight, or the ingredient type, of the food contents on user interface 142 of stand mixer 100. In general, controller 120 may be configured to reacquire the values repeatedly throughout the operation of the stand mixer 100. When the values of the parameter of food contents and the operating parameter from the sensors are received at controller 120, controller 120 may be configured to compute a stopping time, e.g., a desired end time, for the mixing process based on the values of the parameter of food contents and/or the operating parameter. These values may include, but are not meant to be limited to, weight of the food contents, time, and torque of motor 112.

The mixing process may be generally initiated by a user by either manually pressing a switch on user interface 142, or using an external device, such as a smartphone, wirelessly connected to controller 120 in the stand mixer 100. For example, the switch (not shown) on user interface 142 may be an electromagnetic switch or servo switch. When the process is initiated, an overall mixing run timer may also be started by controller 120. The overall mixing run timer may include an upper and a lower limit. The mixing process may run through the process as described above, repeatedly checking for a value to be met, or if no value is met when the overall run timer upper limit expires, the operation may be terminated to further prevent over processing of the food contents. For example, controller 120 may continuously monitor time, along with torque from torque meter 126, in order to stop the mixing process at the desired doneness for the food contents, e.g., the viscosity of the mixture, determined by the measured torque of the mixture, may directly correlate to the completeness of the mixing process. In other example embodiments, controller 120 may include sensors configured to monitor, or take into consideration, ingredient temperature, mixer temperature, and/or altitude.

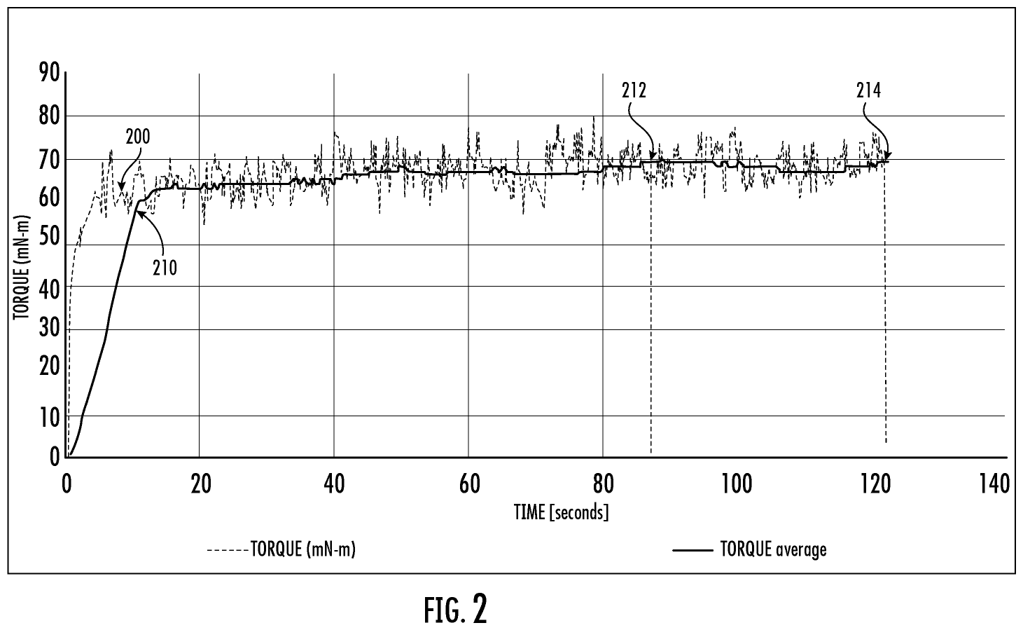

As generally described above, controller 120 may be configured to operate motor 112 to rotate mixer shaft 109 and thereby rotate attachment 108 to mix food contents, e.g., which may be positioned in a utensil (e.g., mixing bowl) below the gearbox 114 and/or above the scale 122, and receive a measurement of an operating parameter of motor 112, e.g., a torque of motor 112, while operating motor 112 to mix the food contents. However, measuring the torque of motor 112 may be difficult, as noise from the mixing operation of stand mixer 100 may interfere with the torque measurement, as will be explained hereinbelow with reference to FIG. 2. In general, to reduce the noise interference in the torque measurement, controller 120 may be configured to filter the noise interference from the measurement of the operating parameter (the torque) of motor 112. Because of the filtering of the noise interference, controller 120 may determine the desired end time based on the filtered measurement of the operating parameter of motor 112. Accordingly, stand mixer 100 may mix the food contents until reaching the desired end time, whereby the mixing operation is completed.

In general, filtering the noise interference from the measurement of the operating parameter of motor 112 may include controller 120 further configured to perform a mathematical evaluation of the measurement of the operating parameter of motor 112 in order to remove the noise interference. In some example embodiments, the mathematical evaluation of the measurement of the operating parameter of motor 112 may include controller 120 configured to calculate a moving average of the measurement of the operating parameter of motor 112 in order to remove the noise interference. In particular, a user may use user interface 142 to initiate specific recipes, wherein the window size of the moving average may be specific to each recipe, e.g., the window size of the moving average may be variable in order to accommodate different types of torque plots, such as flat torque curves, constantly descending torque curves, constantly increasing torque curves (FIG. 2), etc.

In other example embodiments, controller 120 may be further configured to record a baseline torque value for comparison with measurements while motor 112 operates to mix food contents. In some example embodiments, the baseline torque value may indicate a minimum and/or a maximum torque value within the predetermined time period. In particular, controller 120 may be configured to compare the received measurement of the operating parameter of motor 112 with the baseline torque value and use the comparison to determine an ingredient state of the food contents. For example, determining the ingredient state of the food contents may include determining that the measured torque value is less than the baseline torque value. In this scenario, the comparison allows for safety decisions, specifically, ingredient detection, e.g., stand mixer 100 may stop the mixing operation if no ingredients are detected through the comparison of the measured torque values and the baseline torque value, i.e., an anticipated torque value. Additionally or alternatively, controller 120 may be further configured to initiate a timer in response to receiving a threshold torque reading. In particular, the threshold torque reading may be specific to the food contents being mixed, e.g., the threshold torque reading may be specific to a recipe/instruction of the food contents being mixed. Accordingly, the desired end time may be further based on a predetermined time, wherein, mixing the food contents may occur until reaching the desired end time, e.g., including one of reaching the end of the timer or the end of the predetermined end time. In general, initiating a timer in response to receiving a threshold torque reading may advantageously improve mixing operations of ingredients that may take additional mixing time to properly complete, e.g., particularly when the torque no longer changes, but the mixing is not yet complete.

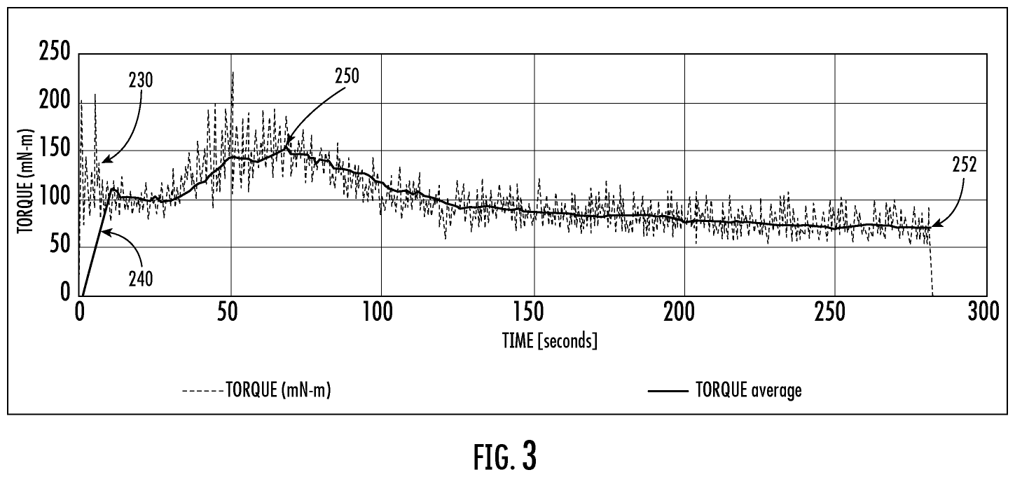

FIGS. 2 and 3 provide graphical representations of data measurements, e.g., torque over time, recorded by stand mixer 100 during a mixing process. In particular, FIGS. 2 and 3 illustrate example embodiments of different recipes stand mixer 100 may be configured to perform. In general, both recipes include a ramp up section at the beginning of the mixing process as motor 142 begins mixing the food contents of stand mixer 100. However, the recipes torque curves differ as the ingredients are mixed, e.g., FIG. 2 illustrates a constantly increasing torque curve, whereas FIG. 3 illustrates a constantly descending torque curve, as will be further explained hereinbelow. As such, the window size of the moving average may be variable in order to accommodate the different types of torque plots.

In particular, FIG. 2 may represent a mixing process of whipped cream in stand mixer 100. As may be seen, the dashed line (e.g., indicated by point 200) extending between zero seconds and one hundred and twenty seconds on the graph represents the measured torque value, without filtering the noise interference, whereas the solid line (e.g., indicated by point 210) represents the torque measurement after filtering the noise interference, e.g., in this scenario the torque value is a moving average, specific to this recipe, calculated from the torque measurement to remove the noise interference. As such, the difference between the torque measurements without filtering the noise interference is too small to be able to determine the change in torque, however, when filtered, the difference is able to be seen. In particular, as stated above, because of the filtering of the noise interference, controller 120 may determine the desired end time based on the filtered measurement of the operating parameter of motor 112. For example, the difference of torque between point 210 (e.g., about 60 mN-m) and point 212 (e.g., about 70 mN-m) is more discernable than the difference between the unfiltered torque between point 200 and point 212. As stated above, some ingredients may include a threshold torque reading, where a timer is initiated in response to measuring the threshold torque reading. For example, between point 212 and point 214 of FIG. 2, upon reaching point 212 (e.g., about 70 mN-m) the torque no longer changes, but the mixing of the ingredients may not yet be completed. As such, in order to advantageously improve mixing operations of the ingredients that may take additional mixing time to properly complete, a timer may be started upon reaching point 212, e.g., point 212 occurs at about ninety seconds into the mixing operation, and the timer may add thirty seconds, such that the mixing operation ends at point 214 at about one hundred and twenty seconds. Accordingly, the additional mixing time may allow the ingredients to properly complete mixing, even though the torque no longer changes. Otherwise, as in other example embodiments, the predetermined end timer may be initiated at the start of the mixing operation, such as for one hundred and forty seconds, so as to prevent overworking the ingredients.

In particular, FIG. 3 may represent a mixing process of creaming ingredients in stand mixer 100. As may be seen, the dashed line (e.g., indicated by point 230) extending between zero seconds and about two hundred and seventy-five seconds on the graph represents the measured torque value, without filtering the noise interference, whereas the solid line (e.g., indicated by point 240) represents the torque measurement after filtering the noise interference, e.g., in this scenario the torque value is another moving average, specific to this recipe, calculated from the torque measurement to remove the noise interference. As may be seen, the torque value may reach a maximum torque at a peak 250, and then steadily decrease between peak 250 and an end point 252, when the mixing process is complete. In general, peak 250 may be the baseline torque value indicating the maximum torque value within the predetermined time period. In particular, controller 120 may be configured to compare the received measurement of the operating parameter of motor 112 with the baseline torque value and use the comparison to determine an ingredient state of the food contents.

As one skilled in the art will appreciate, the above described embodiments are used only for the purpose of explanation. Modifications and variations may be applied, other configurations may be used, and the resulting configurations may remain within the scope of the invention. For example, stand mixer 100 is provided by way of example only and aspects of the present subject matter may be incorporated into any other suitable stand mixer appliance.

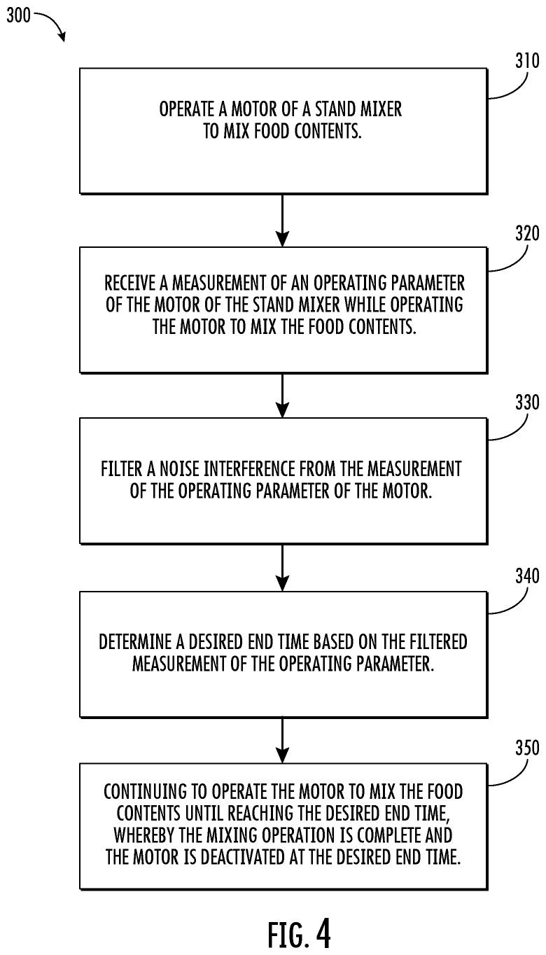

Referring now to FIG. 4, a flow diagram of one embodiment of a method 300 of operating stand mixer 100 is illustrated in accordance with aspects of the present subject matter. In general, method 300 will be described herein with reference to the embodiments of stand mixer 100 and related elements described above with reference to FIGS. 1-3. However, it should be appreciated by those of ordinary skill in the art that the disclosed method 300 may generally be utilized in association with apparatuses and systems having any other suitable configuration. In addition, although FIG. 4 depicts steps performed in a particular order for purposes of illustration and discussion, the method discussed herein is not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 4, at (310), method 300 may generally include operating motor 112 of stand mixer 100 to mix food contents. At (320), method 300 may generally include receiving, at controller 120, the measurement of an operating parameter (torque) of motor 112 of stand mixer 100 while operating motor 112 to mix the food contents. At (330), method 300 may generally include filtering, by controller 120, the noise interference from the measurement of the operating parameter of motor 112. At (340), method 300 may generally include determining, at controller 120, the desired end time based on the filtered measurement of the operating parameter. At (350), method 300 may generally include continuing to operate motor 112 to mix the food contents until reaching the desired end time, whereby the mixing operation is complete and motor 112 may be deactivated at the desired end time.

As may be seen from the above, a stand mixer may include an algorithm that uses mathematical processes for evaluating measured torque data to remove noise from data curves in order to improve the accuracy of the data meant for torque difference measurements. This torque difference may be used in determining the doneness, or desired time to doneness of a recipe. In the algorithm, a baseline torque value may be measured and updated to choose a minimum and/or a maximum value of torque within a preset time or data points. These maximum and/or minimum torque values may be used as a base for comparison to determine the current state of the ingredients. In the algorithm, a timer may be started at a specified torque reading. The timer can start either after a predetermined time from measuring a threshold torque change or at a set time relative to the time marked at the minimum or the maximum torque value. Further, the algorithm may allow the stand mixer to detect if an ingredient has been added or not, and the operation of the stand mixer may be stopped if ingredients are not detected.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a stand mixer, the stand mixer comprising a housing, a motor disposed in the housing, and a controller, the method comprising:
operating the motor to mix food contents;
receiving, at the controller, a measurement of an operating parameter of the motor of the stand mixer while operating the motor to mix the food contents;
filtering, by the controller, a noise interference from the measurement of the operating parameter of the motor;
determining, at the controller, a desired end time based on the filtered measurement of the operating parameter; and
continuing to operate the motor to mix the food contents until reaching the desired end time, whereby the mixing operation is complete and the motor is deactivated at the desired end time.

2. The method of claim 1, further comprising:
receiving, at the controller, a signal indicative of a parameter of food contents in the stand mixer,
wherein the parameter of food contents is one or more of weight, ingredient type, and ingredient temperature.

3. The method of claim 2, wherein, when receiving the signal indicative of the parameter of food contents in the stand mixer, the signal is from one or both of a user input and a sensor measurement.

4. The method of claim 1, wherein, when receiving the measurement of the operating parameter of the motor, the measurement received is a torque of the motor.

5. The method of claim 1, wherein filtering the noise interference from the measurement of the operating parameter of the motor comprises a mathematical evaluation of the measurement of the operating parameter of the motor in order to remove the noise interference.

6. The method of claim 5, wherein filtering the noise interference from the measurement of the operating parameter of the motor comprises calculating a moving average of the measurement of the operating parameter of the motor in order to remove the noise interference.

7. The method of claim 1, wherein receiving the measurement of the operating parameter of the motor comprises recording a baseline torque value for comparison with measurements while the motor operates to mix food contents.

8. The method of claim 7, further comprising comparing the received measurement of the operating parameter of the motor with the baseline torque value and determining an ingredient state, wherein determining the ingredient state comprises determining the measured torque value is less than the baseline torque value.

9. The method of claim 1, further comprising initiating a timer in response to receiving a threshold torque reading, the threshold torque reading specific to the food contents being mixed.

10. The method of claim 9, wherein determining the desired end time is further based on a predetermined time, and wherein mixing the food contents until reaching the desired end time comprises one of reaching the end of the timer or the end of the predetermined end time.

11. A stand mixer, comprising:
a housing;
a motor disposed in the housing; and
a controller, the controller configured to:
operate the motor to mix food contents;
receive a measurement of an operating parameter of the motor of the stand mixer while operating the motor to mix the food contents;
filter a noise interference from the measurement of the operating parameter of the motor;
determine a desired end time based on the filtered measurement of the operating parameter of the motor; and
mix the food contents until reaching the desired end time, whereby the mixing operation is completed.

12. The stand mixer of claim 11, wherein the controller is further configured to:
receive a signal indicative of a parameter of food contents in the stand mixer,
wherein the parameter of food contents is one or more of weight, ingredient type, and ingredient temperature.

13. The stand mixer of claim 12, wherein the signal indicative of the parameter of food contents in the stand mixer is from one or both of a user input and a sensor measurement.

14. The stand mixer of claim 11, wherein the measurement received is a torque of the motor.

15. The stand mixer of claim 11, wherein filtering the noise interference from the measurement of the operating parameter of the motor comprises the controller further configured to perform a mathematical evaluation of the measurement of the operating parameter of the motor in order to remove the noise interference.

16. The stand mixer of claim 15, wherein filtering the noise interference from the measurement of the operating parameter of the motor comprises the controller further configured to calculate a moving average of the measurement of the operating parameter of the motor in order to remove the noise interference.

17. The stand mixer of claim 11, wherein receiving the measurement of the operating parameter of the motor comprises controller further configured to record a baseline torque value for comparison with measurements while the motor operates to mix food contents.

18. The stand mixer of claim 17, wherein the controller is further configured to compare the received measurement of the operating parameter of the motor with the baseline torque value and determine an ingredient state, wherein determining the ingredient state comprises determining the measured torque value is less than the baseline torque value.

19. The stand mixer of claim 11, wherein the controller is further configured to initiate a timer in response to receiving a threshold torque reading, the threshold torque reading specific to the food contents being mixed.

20. The stand mixer of claim 19, wherein determining the desired end time is further based on a predetermined time, and wherein mixing the food contents until reaching the desired end time comprises one of reaching the end of the timer or the end of the predetermined end time.
